(19) United States
(12) Patent Application Publication
(10) Pub. No.: US 2012/0112390 A1
(43) Pub. Date: May 10, 2012

(54) STRETCH ROD FOR A TWO-STAGE BLOW MOLDING MACHINE

(76) Inventor: Donald Wayne Miller, Waterville, OH (US)

(21) Appl. No.: 13/294,056

(22) Filed: Nov. 10, 2011

Related U.S. Application Data
(60) Provisional application No. 61/412,082, filed on Nov. 10, 2010.

(51) Int. Cl. B29C 49/00; B29C 55/00; B29C 49/28

(52) U.S. Cl. 264/532; 425/529; 264/291

(57) ABSTRACT

A stretch rod for a blow molding machine is disclosed, the stretch rod having an elongate member having spaced apart ends and a generally conically-shaped end formed on an end of the elongate member. The end has a tip having a first radius of curvature, a first portion adjacent the tip having a second radius of curvature, a second portion adjacent the first portion having a third radius of curvature, and a third portion adjacent the second portion fixing the end to the elongate member having a fourth radius of curvature.

### CROSS-REFERENCE TO RELATED APPLICATIONS

This application claims the benefit of U.S. Provisional Application No. 61/412,082, filed on Nov. 10, 2010. The entire disclosure of the above application is incorporated herein by reference.

### FIELD OF THE INVENTION

The invention relates to a blow molding machine and more particularly to a stretch rod for a two-stage blow molding machine.

### BACKGROUND OF THE INVENTION

This section provides background information related to the present disclosure which is not necessarily prior art.

Stretch rods are employed in blow molding machines used to form plastic containers by a stretch blow molding process. In the case of preforms comprising a thermoplastic material (e.g., polyethylene terephthalate), the preform can be first heated to the right temperature within a blow mold so the preform becomes soft and is more easily formed. For example, the preform can be heated to a temperature above the glass transition temperature (Tg) for the given plastic. The preform can then be stretched by a stretch rod and inflated into a container by supplying compressed gas into the interior of the preform.

In some applications, the stretch rod 100 can be either too small (FIG. 1) causing the stretch rod 100 to “punch through” the bottom 110 of the preform 120 during the stretching portion of the process. Or, a stretch rod 200 can be too large (FIG. 2) causing the edge 210 of the stretch rod 200 to touch the interior wall of the base 220 of the preform 230, creating a pull in the upper region of the preform end cap 240. Both of these situations can cause poor material control in the base and create off-center gates in the final bottle.

It would be desirable to develop a stretch rod design that controls a direction of the preform and a material distribution in the hub area of a base of a container formed from a preform.

### SUMMARY OF THE INVENTION

The present technology includes systems, processes, and articles of manufacture that relate to a stretch rod for controlling a direction of the preform and a material distribution in the hub area of a base of a container formed from a preform.

In one embodiment, a stretch rod for a blow molding machine is provided that comprises an elongate member having spaced apart ends. A generally conically-shaped end portion is formed on one of the ends of the elongate member. The generally conically-shaped end portion comprises a tip having a first radius of curvature, a first portion adjacent the tip having a second radius of curvature, a second portion adjacent the first portion having a third radius of curvature, and a third portion adjacent the second portion having a fourth radius of curvature, the third portion transitioning the conically-shaped end portion to the elongate member.

In another embodiment, a blow molding machine is provided comprising a preform and a stretch rod. The preform comprises a hollow body having an interior bottom and an interior wall. The stretch rod comprises an elongate member having spaced apart ends, wherein one end is configured to mate with the interior bottom of the preform and a portion of the interior wall of the preform.

In another embodiment, a method for stretching a preform is provided. The method comprises mating a stretch rod to a preform. The preform includes a hollow body having an interior bottom and an interior wall. The stretch rod includes an elongate member having spaced apart ends, wherein one end is configured to mate with the interior bottom of the preform and a portion of the interior wall of the preform. The preform is stretched with a force pressing the stretch rod against the preform.

In yet another embodiment, a method of blow molding a container is provided that comprises stretching a preform as described and then blow molding the stretched preform to form the container.

Further areas of applicability will become apparent from the description provided herein. The description and specific examples in this summary are intended for purposes of illustration only and are not intended to liinit the scope of the present disclosure.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a fragmentary cross-sectional elevational view of a stretch rod known in the art shown in a preform;

FIG. 2 is a fragmentary cross-sectional elevational view of another stretch rod known in the art shown in a preform;

FIG. 3 is a fragmentary side elevational view of a stretch rod according to an embodiment of the invention;

FIG. 4 is an enlarged fragmentary side elevational view of an end of the stretch rod of FIG. 3; and

FIG. 5 is a fragmentary cross-sectional elevational view of an embodiment of a stretch rod disposed in a preform according to the present technology.

### DETAILED DESCRIPTION OF EXEMPLARY EMBODIMENTS OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments where possible.

The present technology provides a controlled pull area of a preform during the blow molding process by using a stretch rod mated to the preform. A shape of the tip of the stretch rod substantially conforms to a shape inside of the preform, which provides a controlled pull of the preform in an axial direction. The shape allows a portion of the stretch rod to be in contact with the inner wall of the preform preventing the stretch rod from affecting the material distribution outside the “hub” area of the base. For example, the design of the inner shape of the preform can therefore determine the design for the stretch rod end to provide optimized control in how the preform stretches during the blow molding process.

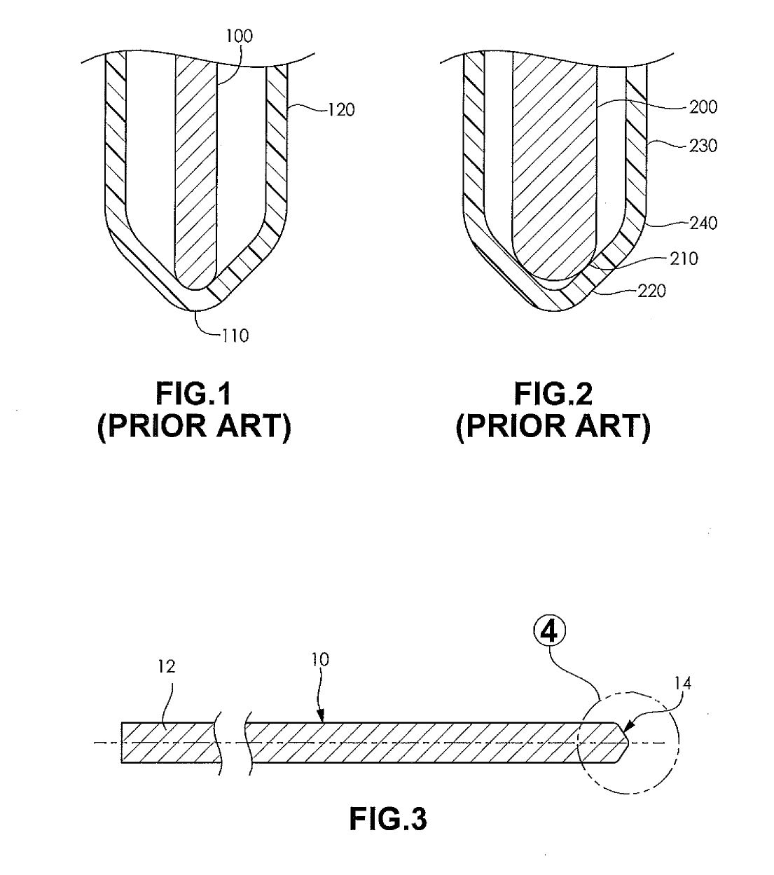

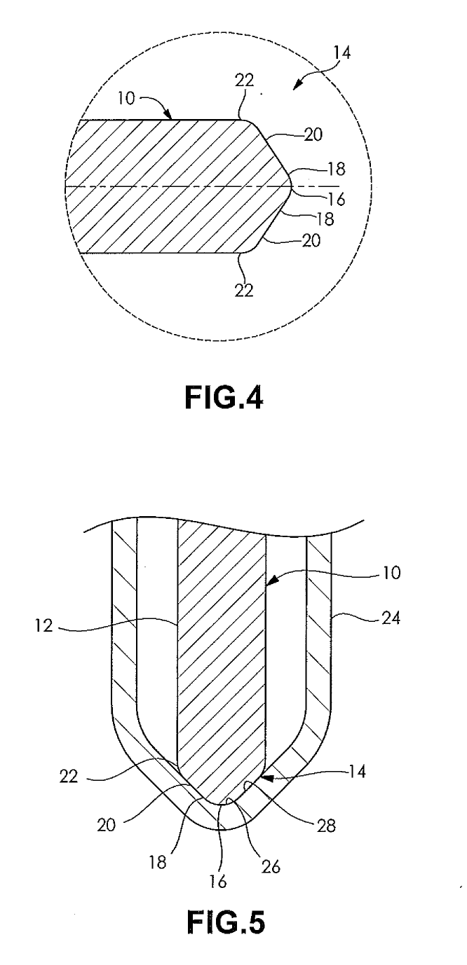

FIGS. 3 and 4 show a stretch rod 10 according to an embodiment of the present technology. A shape of an end of the stretch rod 10 matches a shape of an interior wall of a preform 24, as shown in FIG. 5, which provides a controlled pull of the preform 24 in an axial direction. The shape of the stretch rod 10 allows contact with the bottom 26 and a portion 28 of the interior wall of the preform 24, thereby militating against the stretch rod 10 affecting a material distribution outside of the “hub” area of a base of a container formed from the preform.

In some embodiments, the stretch rod 10 can include an elongate member 12 having an end portion 14 with a generally conical shape. The end portion 14 has a plurality of curvilinear portions having different radii of curvature. A tip 16 of the stretch rod 10 has a first radius of curvature. A portion 18 of the end of the stretch rod 10 adjacent the tip 16 has a second radius of curvature. In some embodiments, the portion 18 can be linear or substantially concave. Another portion 20 of the end of the stretch rod 10 adjacent each of the portions 18 has a third radius of curvature. In some embodiments, the portion 20 can be linear to substantially convex. Another portion 22 of the end portion 14 adjacent the portion 20 couples or fixes the end portion 14 to the elongate member 12. In some embodiments, the portion 22 can be convex and has a fourth radius of curvature. The radii of curvature of each of the tip 16 and the several portions 18, 20, 22 can independently be the same or different, as desired. It is understood that the tip 16 and the several portions 18, 20, 22 can independently be concave, convex, or linear, as desired. It is further understood that the radii of curvature and size of the end portion 14 can vary to conform to the shape of the preform 24.

Referring now to FIG. 5, an embodiment of a stretch rod 10 according to the present technology is shown engaging the preform 24. The end portion 14 of the stretch rod 10 substantially matches or mates with the interior shape of a bottom 26 of the preform 24. The end portion 14 of the stretch rod also mates with a portion of an interior wall 28 of the preform 24. By “mate,” it is meant that the end portion 14 is configured to substantially conform to a shape of or to engage the interior bottom 26 and portion of the interior wall 28 of the preform 24 so that there are substantially no gaps between the end portion 14 and the preform 24; i.e., the end portion 14 is substantially flush with the interior bottom 26 and portion of the interior wall 28. For example, the tip 16 of the stretch rod 10 can have a first radius of curvature that substantially matches the interior shape of the bottom 26 of the preform 24. The portions 18 adjacent the tip 16 can each have a second radius of curvature that substantially matches the portion of the preform 24 between the bottom 26 and the start of the interior wall 28 of the preform 24. The portions 20 adjacent the portions 18 can have a third radius of curvature that substantially matches the interior wall 28 of the preform 24. The portions 22 of the stretch rod 10 that curve away from contacting the preform 24, transitioning to the elongate member 12 of the preform 24, can have a fourth radius of curvature that transitions from substantially matching the interior wall 28 of the preform 24 to no longer contacting the preform 24.

The present technology provides several benefits, including the following aspects. The shape of the tip 16 of the stretch rod 10 can match the shape of the bottom interior of the preform 24, which provides controlled pull of the preform 24 in the axial direction. The mated shape of the stretch rod 10 with the preform 24 allows a small part of the stretch rod 10 to be in contact with the inner wall 28 of the preform 24, beyond just the bottom of the preform 24, preventing it from affecting the material distribution outside the “hub” area of the base. The stretch rod 10 is less prone to punch through the bottom of the preform 24 during the stretching process. Also, since the stretch rod 10 is not stretching the preform 24 by engaging only the interior wall without also engaging the tip, the bottom of the preform 24 can be more uniformly stretched providing better material distribution.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A stretch rod for a blow molding machine comprising:
an elongate member having spaced apart ends; and
a generally conically-shaped end portion formed on one of the ends of the elongate member, the generally conically-shaped end portion comprising a tip having a first radius of curvature, a first portion adjacent the tip having a second radius of curvature, a second portion adjacent the first portion having a third radius of curvature, and a third portion adjacent the second portion having a fourth radius of curvature, the third portion transitioning from the conically-shaped end portion to the elongate member.

2. The stretch rod of claim 1, wherein the tip is substantially convex.

3. The stretch rod of claim 1, wherein the first portion is substantially concave

4. The stretch rod of claim 1, wherein the second portion is substantially convex.

5. The stretch rod of claim 1, wherein the third portion is substantially convex.

6. The stretch rod of claim 1, wherein the third radius of curvature and the fourth radius of curvature are different.

7. A blow molding machine comprising:
a preform comprising a hollow body having an interior bottom and an interior wall; and
a stretch rod comprising an elongate member having spaced apart ends, wherein one end is configured to mate with the interior bottom of the preform and a portion of the interior wall of the preform.

8. The blow molding machine of claim 7, wherein the interior bottom of the preform and the portion of the interior wall of the preform are substantially conical.

9. The blow molding machine of claim 7, wherein the end configured to mate with the interior bottom of the preform and a portion of the interior wall of the preform comprises a generally conically-shaped end portion comprising a tip having a first radius of curvature, a first portion adjacent the tip having a second radius of curvature, a second portion adjacent the first portion having a third radius of curvature, and a third portion adjacent the second portion having a fourth radius of curvature, the third portion transitioning the conically-shaped end portion to the elongate member.

10. The blow molding machine of claim 7, wherein the one end is configured to mate with the interior bottom of the preform and a portion of the interior wall of the preform when the preform is not heated.

11. The blow molding machine of claim 7, wherein the preform is heated and the one end of the stretch rod is engaging the bottom of the preform and a portion of the wall of the preform.

12. The blow molding machine of claim 7, wherein the preform comprises polyethylene terephthalate.

13. A method for stretching a preform comprising:
mating a stretch rod to a preform, the preform comprising a hollow body having an interior bottom and an interior wall and the stretch rod comprising an elongate member having spaced apart ends, wherein one end is configured to mate with the interior bottom of the preform and a portion of the interior wall of the preform; and
stretching the preform with a force pressing the stretch rod against the preform.

14. The method of claim 13, further comprising heating the preform.

15. The method of claim 14, wherein the preform comprises a thermoplastic and the heating comprises heating the preform above the glass transition temperature of the thermoplastic.

16. The method of claim 13, wherein the end configured to mate with the interior bottom of the preform and a portion of the interior wall of the preform comprises a generally conically-shaped end portion comprising a tip having a first radius of curvature, a first portion adjacent the tip having a second radius of curvature, a second portion adjacent the first portion having a third radius of curvature, and a third portion adjacent the second portion having a fourth radius of curvature, the third portion transitioning the conically-shaped end portion to the elongate member.

17. The method of claim 13, wherein the preform comprises polyethylene terephthalate.

18. A method of blow molding a container comprising:
stretching a preform according to the method of claim 13; and
blow molding the stretched preform to form the container.

19. The method of claim 13, wherein the preform comprises polyethylene terephthalate.
